(19) United States
(12) Patent Application Publication
(10) Pub. No.: US 2013/0087259 A1
(43) Pub. Date: Apr. 11, 2013

(54) PROCESS AND PLANT FOR PRODUCING TYRES FOR VEHICLE WHEELS

(71) Applicant: Gianni Mancini, Milano (IT)

(72) Inventor: Gianni Mancini, Milano (IT)

(73) Assignee: PIRELLI TYRE S.p.a.

(21) Appl. No.: 13/702,248

(22) PCT Filed: May 20, 2011
(86) PCT No.: PCT/IB2011/052211

§ 371 Date: Dec. 5, 2012

Related U.S. Application Data
(60) Provisional application No. 61/362,171, filed on Jul. 7, 2010.

(30) Foreign Application Priority Data
Jun. 29, 2010 (IT) MI2010A001176

(51) Int. Cl. B29D 30/06

(52) U.S. Cl. CPC B29D 30/06
USPC 152/209.1; 156/297; 156/196; 156/394.1

(57) ABSTRACT

A tread band of raw elastomeric material is circumferentially applied around a bearing structure incorporating reinforcing cords, for forming a green tyre subsequently submitted to a curing treatment. The tread band is formed by: making an underlayer of raw elastomeric material; making blocks of raw elastomeric material; and applying the blocks mutually spaced apart according to a predetermined tread pattern, onto the underlayer. During introduction of the tyre into a curing mould, the blocks are put in alignment with respective forming recesses before closing the mould, so that each block is engaged in the respective forming recess, following closure of the mould.

The present invention relates to a process and a plant for producing tyres for vehicle wheels. It is also an object of the present invention to provide a tyre for vehicle wheels obtainable through the aforesaid process and/or apparatus.

The present invention is specifically suitable for production of tyres adapted to operate on grounds of weak consistency such as on earth, mud and the like, of the type usually employed in building yards and mounted on excavators, cranes and the like, for example.

A tyre for vehicle wheels generally comprises a bearing structure the task of which is to ensure the tyre structural integrity by withstanding the inflating pressure and the loads due to the vehicle's weight, as well as the dynamic stresses on running. The bearing structure usually comprises a carcass including one or more plies incorporating textile or metallic reinforcing cords. The plies have respectively opposite end flaps in engagement with respective annular anchoring structures integrated into the regions usually identified as “beads” and having an inner diameter substantially corresponding to a so called “fitting or seating diameter” of the tyre on a respective mounting rim.

Associated with the carcass is a belt package comprising one or more belt layers or sheets, disposed in radially superposed relationship with each other and the carcass plies, having textile or metallic reinforcing cords with a crossed orientation and/or substantially parallel to the circumferential extension direction of the tyre. A tread band of elastomeric material is applied at a radially external position to the belt structure or breaker the function of which is to transmit the dynamic stresses between the tyre and ground.

In addition, respective sidewalls of elastomeric material are applied at an axially external position to the side surfaces of the carcass structure, each extending from one of the side edges of the tread band until close to the respective annular anchoring structure to the beads.

After building of the green tyre carried out through assembly of respective components, a curing and moulding treatment is carried out which aims at determining structural stabilisation of the tyre through cross-linking of the elastomeric compositions as well as impressing the tyre with a desired tread pattern and optional distinctive graphic marks at the tyre sidewalls. To this aim, the green tyre is introduced into a curing mould comprising mutually approachable portions that, in the vicinity of the tread band, have suitable depressions and elevations adapted to penetrate the tread band for impressing it with a desired tread pattern, made up of blocks mutually separated by hollow parts and/or grooves.

The Applicant has ascertained that at least in tyres of the type usually employed on big motor-vehicles such as excavators, cranes and the like, designed to operate on grounds of weak consistency such as earth, mud and the like, as in may happen in building yards, quarries, mines, tread patterns characterised by blocks of big sizes are usually required, which normally have an elongated configuration in a direction transverse or oblique to the circumferential extension of the tyre, alternated with large grooves of great depth, for enabling the vehicle's mobility and above all for transmitting the pulling action required by the handled high loads to the ground.

In this context, the Applicant has noticed that, due to the necessity to impress the tyre with such a tread pattern concurrently with closure of the tyre into the mould, the forced displacement of important masses of raw elastomeric material becomes indispensable, for forming said blocks and grooves starting from a tread band of substantially constant thickness. This circumstance determines the requirement of transmitting high forces for closing the mould, thereby giving rise to stresses that are transmitted to the underlying bearing structure of the tyre.

The Applicant has further noticed that stresses transmitted to the tyre during closure of the mould are not homogeneously distributed but, on the contrary, are particularly concentrated at the grooves that are formed in the tread band. Consequently the belt layers and/or carcass plies are submitted to undesirable inner stresses, undulations and/or anomalous deformations of other type.

Within this context, the Applicant has perceived that by avoiding arising of these inner stresses and anomalous deformations fixed through cross-linking of the elastomeric material obtained by curing, it is substantially possible to eliminate arising of those strong unevennesses in strength that can cause early and/or at all events irregular wear of the whole tyre.

The Applicant has then found that if the tread band is built in at least two distinct working operations in which in a first working operation a layer of raw elastomeric material is formed and in a distinct working operation a plurality of blocks are laid on said layer, the shape of said blocks substantially corresponding to the block conformation to be reached in the finished tyre, at the end of the curing and moulding process a tyre substantially clear of inner stresses, undulations and permanent deformations between the carcass plies and belt layers is obtained.

In greater detail, in a first aspect, the invention relates to a process for producing tyres, in which a tread band of raw elastomeric material is circumferentially applied around a bearing structure incorporating reinforcing cords, so as to form a green tyre subsequently submitted to a curing treatment; wherein the tread band is formed by:
making an underlayer of raw elastomeric material;
making blocks of raw elastomeric material
applying the blocks mutually spaced apart according to a predetermined tread pattern, onto the underlayer.

It is the Applicant's opinion that the green tyre thus built is adapted to be submitted to a conventional curing treatment within a mould. During closure of the mould on the tyre, the blocks provided on the tread band will be fitted into the corresponding depressions or recesses provided in the vulcanisation mould for final geometric definition of the tread pattern.

Closure of the mould can therefore take place without inducing important stresses on the raw elastomeric material forming the tread band and the underlying belt and carcass structures, thus preserving the structural integrity and homogeneity of the finished tyre.

In accordance with a second aspect, the invention relates to a plant for producing tyres, comprising:
devices for making a bearing structure incorporating reinforcing cords;
devices for applying a tread band circumferentially around the bearing structure, so as to form a green tyre;
devices for curing the tyre;
   wherein the devices for applying the tread band comprise:
a location for forming an underlayer of raw elastomeric material;
a location for forming blocks of raw elastomeric material;
a location for applying the blocks onto the underlayer, in mutually spaced apart relationship according to a predetermined tread pattern.

In accordance with a third aspect, the invention relates to a green tyre for vehicle wheels comprising a tread band of elastomeric material circumferentially disposed around a bearing structure incorporating reinforcing cords,

wherein the tread band comprises
an underlayer circumferentially extending around the bearing structure;
a plurality of mutually spaced apart blocks according to a predetermined tread pattern and applied each onto the underlayer at respective mutually-connected surfaces.

The present invention, in at least one of the aforesaid aspects, can have one or more of the preferred features hereinafter described.

The underlayer is applied around the bearing structure before application of the blocks onto the underlayer. Thus it is possible to form the tread band directly on the bearing structure of the tyre, comprising a belt package and/or a carcass.

The underlayer can be made by extrusion of at least one continuous elongated element of raw elastomeric material and circumferential winding of said continuous elongated element into a plurality of coils disposed mutually in side by side relationship around the bearing structure.

The underlayer can also be made by extrusion of at least one continuous strip of elastomeric material of cross-section substantially corresponding to the cross section of the underlayer, and separation of a strip segment of predetermined length from said continuous strip.

In a further example, the underlayer is applied around the bearing structure after application of the blocks to the underlayer. Thus the cycle time can be optimised by manufacturing the tread band in a work location distinct from that where assembly of other tyre parts is carried out.

A first and a second end portions of the underlayer can be mutually joined end-to-end following winding of the underlayer around the bearing structure.

Separation of the strip segment is preferably carried out following a cutting line extending along a groove or hollow part defined, in the pattern between circumferentially contiguous blocks. Thus accomplishment of the end-to-end splicing is facilitated.

At least one of the blocks can be also provided to protrude from the second end portion of the underlayer for application against the first end portion of the underlayer at the end of winding of the underlayer around the bearing structure.

During application of the blocks to the underlayer, the elastomeric material forming the blocks preferably has a temperature higher than 50° C.

During application of the blocks to the underlayer, the elastomeric material forming the underlayer preferably has a temperature higher than 50° C.

A sufficiently high temperature of the blocks and/or the underlayer during application facilitates efficient adhesion of the blocks to the underlayer.

To promote maintenance of a desired temperature after manufacture of the underlayer, heat can be supplied to the underlayer itself, before application of the blocks.

Heat to the blocks before applying them to the underlayer can also be supplied.

At least one of said blocks is preferably made by extrusion of a continuous bar of raw elastomeric material and separation of a bar segment of predetermined length from said continuous bar.

The blocks can be thus made in a simple and cheap manner, the productivity of which can be easily modulated depending on requirements.

It may be also provided that at least one of said blocks be shaped by plastic deformation before being applied to the underlayer.

At least one of said blocks is preferably applied to the underlayer by compressing an attachment surface of the block against an outer surface of the underlayer.

The blocks can be advantageously applied to the underlayer in a top region of the tyre, supported according to a horizontal geometric rotation axis. Thus application of the blocks is facilitated and the risk of separation of same under gravity is eliminated.

Preferably, the curing treatment comprises:
introducing the tyre into a mould having forming recesses corresponding to respective tyre blocks; and
aligning the blocks with the respective forming recesses before closing the mould, so that each block is engaged in the respective forming recess, following closure of the mould. Thus closure of the mould is facilitated without, too many stresses being imposed to the tyre.

Alignment of the blocks to the respective forming recesses can be carried out by causing at least one reference index carried by the tyre to coincide with a fixed reference, which index is indicative of the angular position of the blocks around a geometric rotation axis of the tyre itself.

To this aim, before the curing treatment, at least one reference index indicative of the angular position of the blocks around a geometric rotation axis of the tyre is preferably associated with the tyre itself.

During closure of the mould a centripetal approaching of sectors carrying said forming recesses is preferably carried out.

The elastomeric material utilised in making the underlayer can have a different composition from that of the elastomeric material used in making the blocks.

Said underlayer-forming location may comprise an elongated-element dispensing assembly to supply at least one continuous elongated element of raw elastomeric material, and devices for circumferentially winding said continuous elongated element around the bearing structure of the tyre, in the form of a plurality of coils in mutual side by side relationship.

According to a possible variant, the underlayer-forming location comprises a strip-dispensing assembly for dispensing at least one continuous strip of elastomeric material having cross-section substantially corresponding to the underlayer cross-section, and cutting devices for cutting to size a strip segment of predetermined length from said continuous strip.

Heating devices may be provided for supplying heat to the underlayer before application of the blocks.

Also heating devices for supplying heat to the blocks before applying them to the underlayer may be provided.

Said hating devices preferably operate in the vicinity of the block-applying location.

The block-forming location may comprise a bar-dispensing assembly for supplying a continuous bar of raw elastomeric material and devices for cutting bar segments of predetermined length from said continuous bar.

The block-forming location may further comprise moulding members operating downstream of said cutting devices and upstream of the block-applying location for shaping the blocks by plastic deformation.

The block-applying location may comprise a rest surface for the underlayer and a handling device for laying the blocks onto the underlayer supported by the rest surface.

This handling device will be provided for laying at least one of said blocks protruding from a second end portion of the underlayer.

According to a further example, the block-applying location may comprise a handling device for laving the blocks on the underlayer applied around the bearing structure of the tyre.

Said handling device preferably comprises a gripper having jaws movable between an open condition in which they are mutually spaced apart and a closed condition in which they are mutually approached so as to define a concave seat the shape of which matches that of one of said blocks.

The handling device may comprise a presser member to compress the blocks against an outer surface of the underlayer.

In a preferred embodiment, the devices for curing the tyre comprise:
a mould having forming recesses corresponding to respective tyre blocks; and
reference indices for aligning the blocks with the respective forming recesses before closing the mould, so that each block is engaged in the respective forming recess following closure of the mould.

Said reference indices comprise a fixed reference that can be made coincident with at least one reference index carried by the tyre and is indicative of the angular position of the blocks around a geometric rotation axis of the tyre itself. Provision may be made for devices for associating at least one reference index with the tyre, which index is indicative of the angular position of the blocks around a geometric axis of the tyre, operatively disposed upstream of the devices for curing the tyre.

Preferably, the forming recesses are defined in respective sectors that can be centripetally moved close to each other concurrently with closure of the mould.

In the obtained tyre, the underlayer can have a substantially constant cross-section profile along a longitudinal extension thereof.

The underlayer may comprise at least one continuous elongated element of raw elastomeric material extending circumferentially into a plurality of coils disposed in mutual side by side relationship around the bearing structure.

In a further embodiment, the underlayer comprises at least one strip segment of elastomeric material of cross-section substantially corresponding to the cross section of the underlayer.

The strip segment preferably has a first end portion and a second end portion mutually joined end-to-end. Said end portions have a line of mutual connection extending along a hollow part defined in the tread pattern between circumferentially contiguous blocks.

At least one of said blocks can protrude from the second end portion of the underlayer and be applied against the first end portion of the underlayer.

At least one of said blocks preferably comprises a bar segment separated from a continuous bar of extruded elastomeric material.

The tyre may further comprise at least one reference index indicative of the angular position of the blocks around a geometric rotation axis of the tyre.

The underlayer can be made of an elastomeric material different from that forming the blocks.

Further features and advantages will become more apparent from the detailed description of a preferred but not exclusive embodiment of a process and an apparatus for manufacturing tyres, in accordance with the present invention.

This description will be set out hereinafter with reference to the accompanying drawings, given by way of non-limiting example, in which:

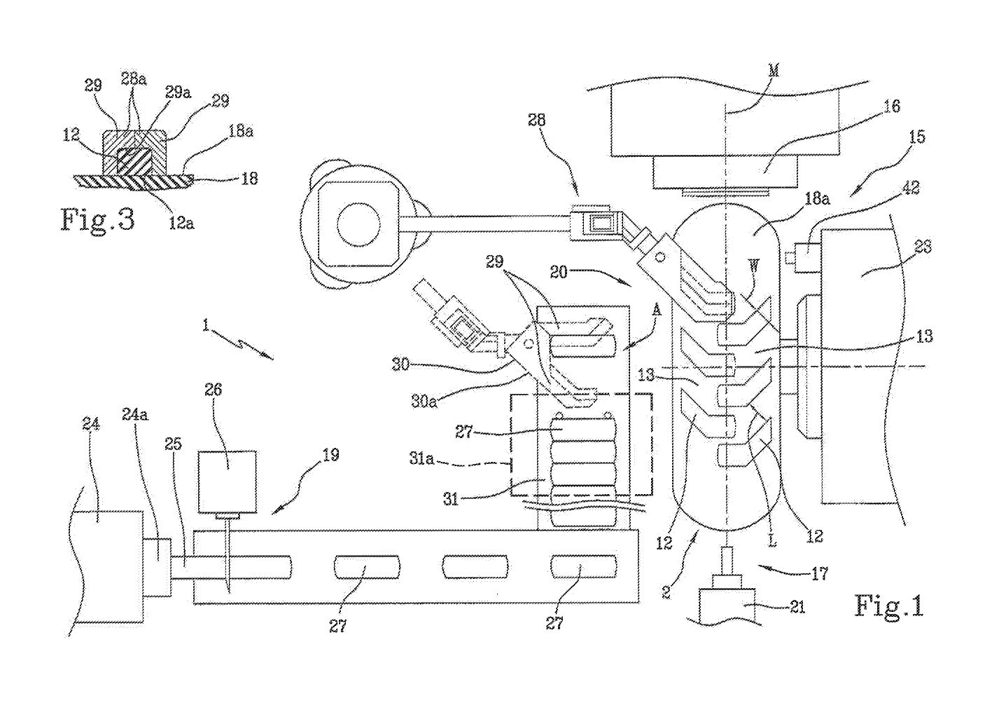

FIG. 1 is a diagrammatic view from above of a plant for manufacturing tyres in accordance with the present invention;

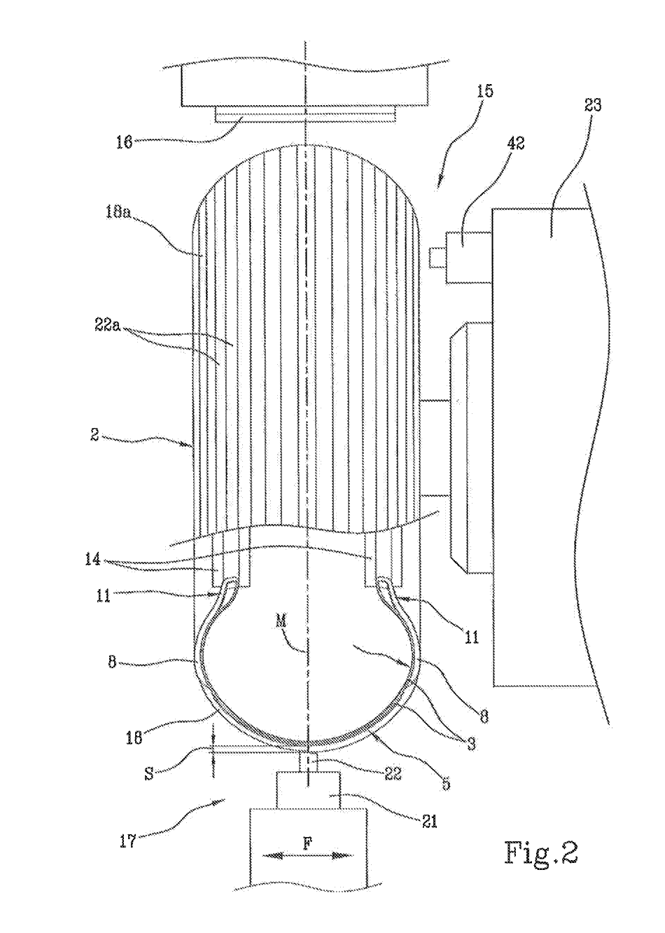

FIG. 2 shows an enlarged detail of FIG. 1 while a different process operation is being carried out;

FIG. 3 is an enlarged cross-section of a detail of a gripper associated with a handling device provided in the plant in FIG. 1;

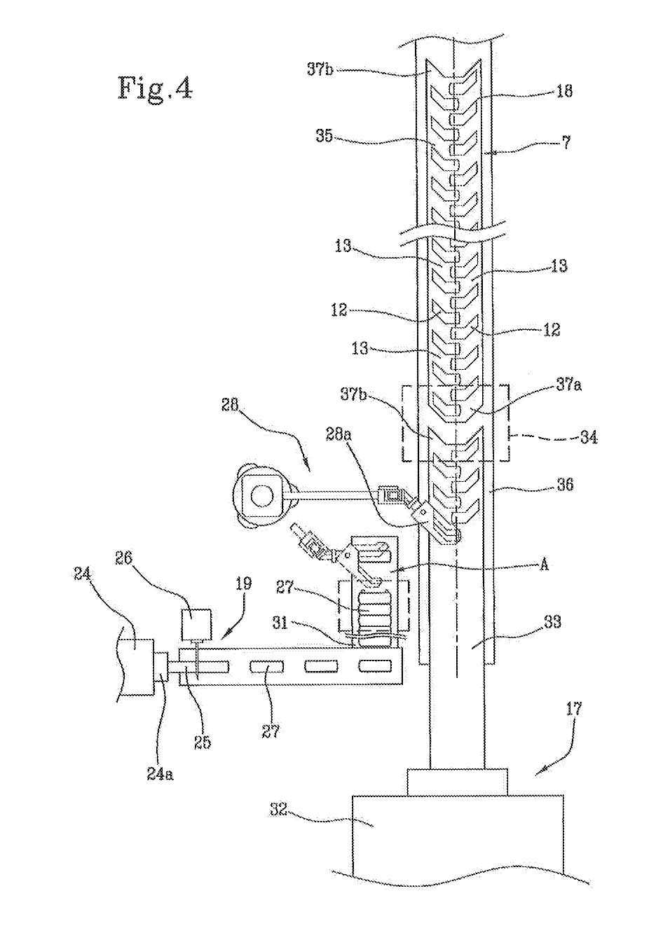

FIG. 4 shows manufacture of a tread band according to a possible variant of the invention;

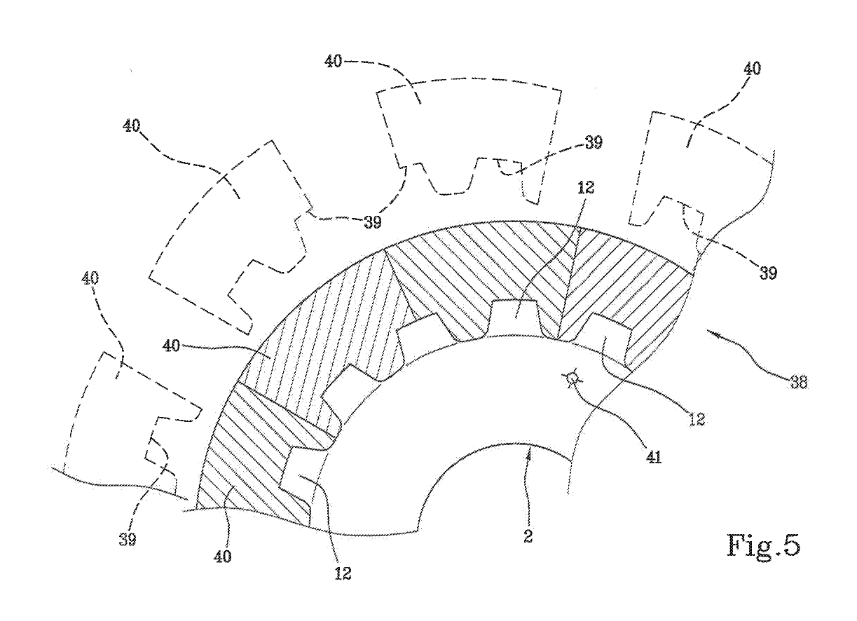

FIG. 5 is a diagrammatic and fragmentary view from above showing introduction of the tyre into a curing mould;

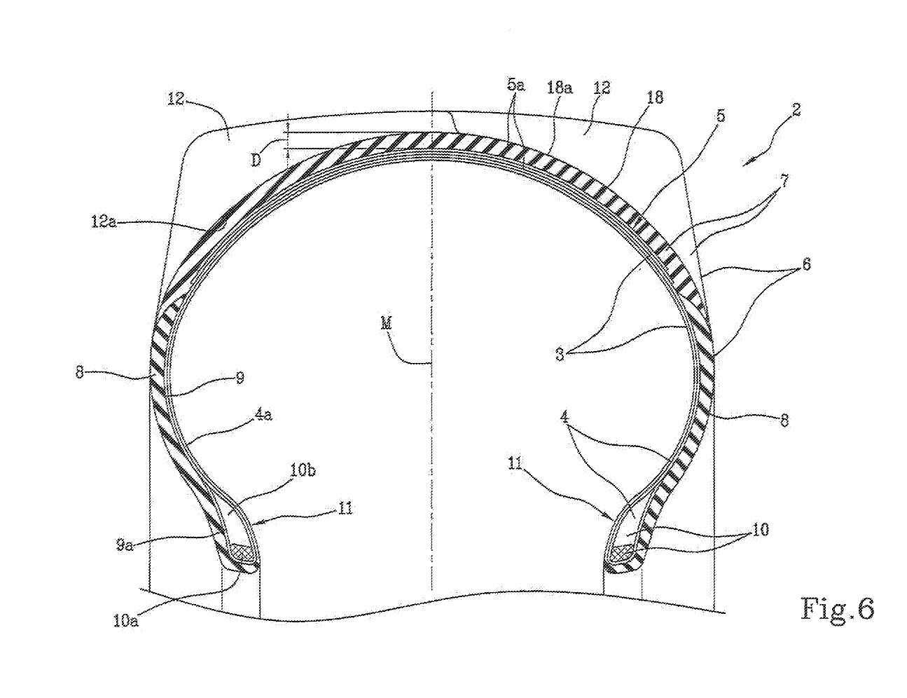

FIG. 6 shows a cross-section of a tyre made in accordance with the invention.

With reference to the drawings, a plant for producing tyres for vehicle wheels provided for carrying out a process according to the present invention has been generally identified with reference numeral 1.

Plant 1 is intended for manufacturing tyres 2, in particular of the type usually employed in building yards for example, mounted on excavators, cranes and the like, intended for also operating on grounds of weak consistency such as earth, mud and the like. These tyres usually have important sizes with an outer diameter included, just as an indication, between about 800 mm and about 2200 mm, and a weight included between about 30 kg and about 500 kg, for example.

As shown in FIG. 6, the tyre essentially comprises at least one bearing structure 3 in which a so-called carcass 4 and a belt package 5 can be identified, as well as an outer coating 6 in which a tread band 6 and a pair of sidewalls 8 can be seen.

Carcass 4 normally comprises one or more radially superposed carcass plies 9, each of them including textile or metallic cords disposed parallel to each other and oriented substantially perpendicular to a circumferential extension direction of the tyre, or following an oblique and preferably crossed orientation relative to possible adjacent carcass plies 9. Two annular anchoring structures 10, each comprising a so-called bead core 10a preferably carrying an elastomeric filler 10b at a radially external position, are in engagement with respective end flaps 9a of the carcass ply or plies 9. The annular anchoring structures 10 are integrated in the vicinity of regions usually identified as “beads” 11, at which normally engagement between tyre 2 and a respective mounting rim (not shown) occurs, according to a fitting diameter determined by the inner diametrical sizes of the annular anchoring structures 10. Carcass 4 can be possibly internally coated with a layer of airtight elastomeric material, a so-called “liner” 4a.

The belt, package 5 usually comprises one or more belt layers 5a circumferentially applied around carcass 4 at an axially centred position relative to an axial symmetry plane “M” perpendicular to the rotation axis of the tyre, each of them comprising textile or metallic cords disposed in oblique orientation relative to the circumferential extension direction and in crossed orientation relative to the adjacent belt layer or layers 5a.

The tread band 7 is circumferentially superposed on the belt package 5 and externally has a plurality of blocks 12 alternated with grooves or hollow parts 13 suitably shaped and distributed so as to define a so-called tread pattern.

In tyres designed to also operate on uneven grounds and/or grounds of weak consistency such as earth, mud and the like, the tread pattern can advantageously have blocks 12 in the form of elongated ribs with a course transverse or oblique to the circumferential extension direction, distributed in one or more axially-approached circumferential rows. The blocks 12 belonging to the same circumferential row are preferably alternated with hollow parts or grooves 13 of big sizes, also having an approximately elongated conformation, with a width “L” that, measured perpendicularly of the longitudinal extension of two adjacent blocks 12, can be equal to or higher than the width “W” measured on the blocks 12 so as to define a so-called solid/hollow ratio included, just as an indication, between about 0.05 and about 0.9, more preferably between about 0.4 and about 0.85.

To the aims of the present specification by “solid/hollow ratio” it is intended a parameter characteristic of the tread pattern indicating the ratio between the overall surface of the grooves or hollow parts of a given portion of the tyre tread pattern (possibly the whole tread pattern) and the overall surface of the given portion of the tread pattern (possibly the whole tread pattern).

The sidewalls 8 are applied to carcass 4 at laterally opposite positions, each extending from the corresponding bead 11 to a corresponding side edge of the tread band 7.

As diagrammatically shown by way of example in FIG. 1, plant 1 comprises devices for manufacturing the bearing structure 3, which devices can for example comprise a first building station, not shown as it can be made in a manner known by itself, at which carcass 4 is made. In the first building station, carcass 4 made in the form of a cylindrical sleeve for example, can be also submitted to application of sidewalls 8.

By possible transfer onto an assembling drum 14 provided in an assembling station 15, carcass 4 is shaped into a toroidal configuration, following axial mutual approaching of beads 11 concurrently with injection of air or other fluid under pressure inside the carcass ply/plies 9.

A dispensing unit 16 can operate in the second building station and it provides the belt layers 5a that, through rotation of the assembling drum 14, are circumferentially wound at a radially external position on carcass 4 having a toroidal conformation, so as to form the belt package 5.

Plant 1 further comprises devices for forming the tread band 7 that can be circumferentially applied around a bearing structure 3 in order to define the green tyre 2, to be submitted to curing.

These devices comprise an underlayer-forming location 17, in which an underlayer 1 of raw elastomeric material is made, said underlayer being part of the tread band 7. Underlayer 18 can have a substantially constant cross-section profile along a longitudinal extension thereof and a thickness “S” included, just as an indication, between about 75% and about 150%, and more preferably included between about 90% and about 110% of the distance “D” to be measured, in said axial symmetry plane “M” of the finished tyre, between a radially external surface of the belt package 5 and a bottom surface of the grooves 13 defined between circumferentially contiguous blocks 12 in the tyre itself.

Also provided is a block-forming location 19, at which blocks 12 of raw elastomeric material are made. A block-applying location 20 carries out application of blocks 12 mutually spaced apart according to the desired tread pattern, onto the underlayer 18.

In accordance with a first example of the invention shown in FIGS. 1 and 2, the underlayer-forming location 17 comprises an elongated-element dispensing assembly 21, a first extruder for example, designed to supply at least one continuous elongated element 22 of raw elastomeric material and devices for winding said continuous elongated element 22 circumferentially around the bearing structure 3 of tyre 2 in greater detail, the bearing structure 3 of tyre 2 under process can be supported by a drum in turn supported by an actuating assembly 23, by which the drum itself is driven in rotation in front of the elongated-element dispensing assembly 21.

In the example shown, said drum consists is the assembling drum 14 itself, provided in the assembling station 15 of which the actuating assembly 23 is an integral part.

Through axial-distribution movements imparted to the elongated-element dispensing assembly 21 (see arrow F in FIG. 2) and/or to drum 14, the continuous elongated element 22 is wound around the bearing structure 3 into circumferential coils 22a in mutual side by side and/or superposed relationship, so as to make the underlayer 18 according to desired features in terms of thickness “S” and cross-section profile, before carrying out application of the blocks 12 to the underlayer itself.

The block-forming location 19 designed to make blocks 12 can comprise a bar-dispensing assembly 24, a second extruder for example, supplying a continuous bar 25 of raw elastomeric material, having a cylindrical section of a width approximately corresponding to that of blocks 12 to be applied to the underlayer 18. Combined with the bar-dispensing assembly 24 are cutting devices 26 separating bar segments 27 of predetermined length from the continuous bar 25. These cutting devices 26 can for example comprise a blade set in reciprocating motion at an outlet die 24a of the extruder dispensing said continuous bar 25.

Each bar segment 27 is designed to form one of blocks 12 to be applied to the underlayer 18 at the block-applying location 20 that to this aim can comprise at least one handling device 20 for laying blocks 12 on the underlayer 18 applied around the bearing structure 3 of tyre 2.

The handling device 28 preferably comprises an anthropomorphic robotized arm carrying a gripper 28a having jaws 29 movable between an open condition at which they are mutually spaced and a closed condition at which they are close to each other, for defining a concave seat 29a the shape of which matches that of one of said blocks 12.

Moulding members operating downstream of the cutting devices 26 and upstream of the block-applying location 20 can be provided for shaping by plastic deformation, the bar segments 27 obtained from the continuous bar 25, so as to give the blocks 12 a desired conformation. For instance, these moulding members can comprise the same gripper 28a being part of the handling device 28 installed in the applying location, the concave seat 29a of which will be suitably shaped for impressing each block 12 with a desired conformation in cross-section and/or in the longitudinal extension.

The handling device 26 can also comprise a presser member 30 to compress blocks 12 against an outer surface 18a of the underlayer 18.

In the example shown, this presser member 30 too consists of the same gripper 28a being part of the handling device 28, which gripper is provided, if necessary, of at least one counter-surface 30a, designed to act in thrust relationship against the block 12 applied to an underlayer 18. If required, by appropriate movements of gripper 28a carried out by the handling device 28, the action of the counter-surface 30a ensures efficient application of block 12, even when the outer surface 18a of the underlayer 18 has a profile showing a marked transverse curvature.

In operation, the bar segments 27 sequentially produced upon the action of the cutting devices 26 are preferably laid on a storage unit 31, represented by a roller chute for example, designed to receive the individual bar segments 27 produced by the cutting devices 26 to bring them one by one to a predetermined grip region “A” by means of the handling device 28. The storage unit 31 makes it possible to uncouple operation of the bar-dispensing assembly 24 that can operate in a continuous manner, from operation of the block-applying location 20 that, in the example shown, is discontinuous because application of blocks 12 only begins at the end of application of the belt layers 5a and the underlayer 18.

The storage unit 31 can advantageously have a storage capacity preferably included between about 80% and about 120% of the amount of blocks 12 to be used for manufacture of one tread band 7. This amount of stored blocks 12 is of such a nature that it does not involve too long, waiting times between manufacture and true application of each block 12, so as to ensure that at the moment of application the elastomeric material of each block 12 still has a sufficiently high temperature for promoting steady coupling of said block with the underlayer 18.

In case of need, heating devices 31a comprising infrared lamps for example, can be provided for operating on the blocks 12 reaching the block-applying location 20 and/or on the underlayer 18 applied on tyre 2 under process, to enable the temperature of the elastomeric material, constituting blocks 12 and/or underlayer 18 to have a value, during application, preferably included between about 50° C. and about 130° C., and more preferably included between about 60° C. and about 100° C.

For purposes of application, the handling device 28 brings gripper 28a close to the storage unit 31 to pick up a block 12 from the grip region “A”. Gripper 28a, provided in the open condition, is actuated to move laws 29 close to each other to the closed condition, thus determining engagement of block 12 and possible moulding of same by plastic deformation into the desired configuration.

The handling device 28 brings block 12 against the outer surface 18a of underlayer 18, preferably at a top region of tyre 2, supported according to a horizontal geometric rotation axis “X”. Thus the risk that block 12 may separate from underlayer 18 and fall under gravity is eliminated when gripper 28a is brought again to the open condition for leaving block 12 on the tyre 2 under process.

By possible rotation of gripper 28a, the counter-surface 30a can be brought into thrust relationship against block 12 released on the tyre 2 under process, so that the block is compressed at an attachment surface 12a thereof against the outer surface 18a of underlayer 18, to promote steady mutual adhesion.

An angular rotation of the assembling drum 14 by a step equal to the predetermined distribution step of blocks 12 makes the tyre itself ready for application of a new block 12 disposed circumferentially in side by side relationship with the previously applied block 12.

The above described operating cycle of the block-applying location 20 is repeated until application of blocks 12 around the tyre 2 under process is completed, in one or more axially approached circumferential rows.

In FIG. 4 manufacture of the tread band 7 in accordance with a further example of the invention is diagrammatically shown.

According to this further example, the underlayer-forming location comprises a strip-dispensing assembly 32 designed to supply at least one continuous strip 33 of elastomeric material, the cross-section of which substantially corresponds, at least in terms of cross-section sizes, to the cross-section of underlayer 18.

Associated with the strip-dispensing assembly 32, comprising a second extruder for example, are measure-cutting devices 34 only diagrammatically shown) designed to separate a strip segment 35 of predetermined length from the continuous strip 33, said length being preferably the same as the circumferential extension of the underlayer 18 to be applied to tyre 2 under process.

This strip segment 35 can constitute by itself the underlayer 18 to be applied to tyre 2 under process, once application of blocks 12 to the underlayer itself has been completed. To this aim, underlayer 18 can be disposed on a preferably flat rest surface 36 to be submitted to the action of the handling device 28 applying blocks 12 in the same manner as described with reference to the example shown in FIG. 1.

When application of blocks 12 has been completed, the tread band 7 thus obtained can be applied around the bearing structure 3 of tyre 2 under process. In particular, application of the tread band 7 contemplates that a first end portion 37a of the underlayer 18 is caused to adhere to the bearing structure 3 of tyre 2, the tread band 7 being subsequently circumferentially wound around the whole circumferential extension of tyre 2 until making a second end portion 37b match the previously applied first end portion 37a. The end portions 37a, 37b of underlayer 18 are thus mutually joined end-to-end at the end of application of the tread band 7 to tyre 2.

To facilitate this splicing operation, separation of the strip segment 35 from the remaining continuous strip 33 can be carried out following a cutting line extending along one of grooves 13 defined in the tread pattern, between circumferentially contiguous blocks 12, preferably according to a course parallel to the blocks 12 themselves.

Alternatively, the separation can be carried out for example following a cutting line perpendicular to the longitudinal extension of the underlayer 18. In this case, the handling device 28 can be designed to lay one or more of blocks 12 in such a manner that they partly protrude from the second end portion 37b of the underlayer 18. The protruding portions of blocks 12 will overlap the first end portion 37a of the underlayer 18 already applied to tyre 2 under process, at the end of the tread-band applying step 7 around the circumferential extension of the tyre under process.

The built tyre 2 lends itself to be removed from the assembling station 15 for being submitted to a final curing and moulding treatment. To this end, tyre 2 is submitted to the action of curing devices comprising a mould 38 having forming recesses 39 the conformation of which corresponds to that of the respective blocks 12 to be obtained in the finished tyre 2. Preferably, these forming recesses 39 are defined in respective circumferential sectors 40 of mould 38, that can be centripetally moved close to each other towards a geometric reference axis coincident with the geometric rotation axis “X” of tyre 2, concurrently with closure of the mould 38. The green tyre 2 is introduced into mould 38 provided in an open condition, sectors 30 being radially moved apart relative to the geometric reference axis.

Before closing mould 38, the blocks 12 previously applied to the tread band 7 are aligned in a radial direction relative to the corresponding forming recesses 39. Consequently each block 12 is introduced into, and remains in engagement in the respective forming recess 39 when, following closure of mould 38, sectors 40 move radially close to the geometric reference axis for compressing and moulding the tread band 7.

Alignment of blocks 12 with the respective forming recesses 39 can be advantageously facilitated by fitting of at least one reference index 41 carried by tyre 2, indicative of the angular position of blocks 12 around the geometric axis of the tyre 2 itself. This reference index 41 can consist for example of one of the corners of a block 12 or any other point that can be uniquely identified along the circumferential extension of the tread band 7.

In accordance with a preferred solution, the reference index 41 is however provided to be associated with tyre 2 before carrying out the curing treatment, for instance by means of a mark made by a stamping apparatus 42 associated with the assembling station 15 or other devices operating upstream of mould 38.

The mark or other reference index 41 is adapted to be easily identified during introduction of tyre 2 into mould 38, to make it correspond with at least one fixed reference (not shown) provided in the mould 33 itself. This fixed reference can for example consist of a corresponding mark exhibited by mould 38, or integrated into an optical detection unit associated with the mould itself and interfaced with an automatic device for loading tyre 2 into the mould 38.

Closure of mould 38 around tyre 2 already provided with blocks 12 in alignment with the respective forming recesses 39 can easily take place without submitting tyre 2 to the important stresses required in the known art for forming the blocks 12 into the thickness “S” of the tread band 7.

At all events the conformation of the forming recesses 39 can be of such a nature as to enable the conformation of blocks 12 and/or underlayer 18 of the tread band 7 to be trimmed or to receive a greater definition. The transmitted stresses for obtaining this deformation would be in any case of negligible amount if compared with the amount of stresses imposed in the known art.

Accomplishment of blocks 12 separately from underlayer 18 also enables use, if necessary, of elastomeric materials of different compositions for manufacture of blocks 12 and underlayer 18, respectively. For instance, blocks 12 can be made using a softer compound than that of underlayer 18. Underlayer 18 in turn can be made using a compound having better hysteresis properties than those of block 12.

1-49. (canceled)

50. A process for producing a tyre, in which a tread band of raw elastomeric material is circumferentially applied around a bearing structure incorporating reinforcing cords, so as to form a green tyre subsequently submitted to a curing treatment, comprising forming a tread band by:
making an underlayer of raw elastomeric material;
making blocks of raw elastomeric material; and
applying the blocks mutually spaced apart according to a predetermined tread pattern, onto the underlayer.

51. The process as claimed in claim 50, wherein the underlayer is applied around the bearing structure before application of the blocks onto the underlayer.

52. The process as claimed in claim 50, wherein the underlayer is made by extrusion of at least one continuous elongated element of raw elastomeric material and circumferential winding of said continuous elongated element into a plurality of coils disposed mutually in side by side relationship around the bearing structure.

53. The process as claimed in claim 50, wherein the underlayer is made by extrusion of at least one continuous strip of elastomeric material of cross-section substantially corresponding to a cross-section of the underlayer, and separation of a strip segment of predetermined length from said continuous strip.

54. The process as claimed in claim 50, wherein the underlayer is applied around the bearing structure after application of the blocks onto the underlayer.

55. The process as claimed in claim 53, wherein a first and a second end portions of the underlayer are mutually joined end-to-end following winding of the underlayer around the bearing structure.

56. The process as claimed in claim 53, wherein separation of the strip segment is carried out following a cutting line extending along a groove or hollow parts defined in a tread pattern between circumferentially contiguous blocks.

57. The process as claimed in claim 55, wherein at least one of said blocks protrudes from the second end portion of the underlayer and is applied against the first end portion of the underlayer at the end of winding of the underlayer around the bearing structure.

58. The process as claimed in claim 50, wherein, during application of the blocks to the underlayer, the elastomeric material forming the blocks has a temperature higher than 50° C.

59. The process as claimed in claim 50, wherein, during application of the blocks to the underlayer, the elastomeric material forming the underlayer has a temperature higher than 50° C.

60. The process as claimed in claim 50, wherein, after manufacture of the underlayer, heat is supplied to the underlayer before application of the blocks.

61. The process as claimed in claim 50, wherein, after manufacture of the blocks, heat is supplied to the blocks before applying the blocks to the underlayer.

62. The process as claimed in claim 50, wherein at least one of said blocks is made by extrusion of a continuous bar of raw elastomeric material and separation of a bar segment of predetermined length from said continuous bar.

63. The process as claimed in claim 50, wherein at least one of said blocks is shaped by plastic deformation before being applied to the underlayer.

64. The process as claimed in claim 50, wherein at least one of said blocks is applied to the underlayer by compressing an attachment surface of the block against an outer surface of the underlayer.

65. The process as claimed in claim 50, wherein said blocks are applied to the underlayer at a top region of the tyre, supported according to a horizontal geometric rotation axis.

66. The process as claimed in claim 50, wherein said curing treatment comprises:
introducing the tyre into a mould having forming recesses corresponding to respective blocks of the tyre; and
aligning the blocks with the respective forming recesses before closing the mould, so that each block is engaged in a respective forming recess following closure of the mould.

67. The process as claimed in claim 66, wherein alignment of the blocks with respective forming recesses is carried out by making at least one reference index carried by the tyre coincide with a fixed reference, said index being indicative of an angular position of the blocks around a geometric rotation axis of the tyre.

68. The process as claimed in claim 50, wherein, before the curing treatment, at least one reference index indicative of an angular position of the blocks around a geometric rotation axis of the tyre is associated with the tyre.

69. The process as claimed in claim 65, comprising, during closure of the mould, carrying out a centripetal approaching of sectors carrying said forming recesses.

70. The process as claimed in claim 50, wherein the elastomeric material utilised in making the underlayer has a different composition from a composition of the elastomeric material used in making the blocks.

71. A plant for producing a tyre, comprising:
devices for making a bearing structure incorporating reinforcing cords;
devices for forming a tread band; and
devices for curing a tyre and said tread band circumferentially applied around the bearing structure,
wherein the devices for forming the tread band comprise:
an underlayer-forming location to make an underlayer of raw elastomeric material;
a block-forming location to make blocks of raw elastomeric material; and
a block-applying location to apply the blocks onto the underlayer, mutually spaced apart according to a predetermined tread pattern.

72. The plant as claimed in claim 71, wherein the underlayer-forming location comprises an elongated-element dispensing assembly to supply at least one continuous elongated element of raw elastomeric material, and devices for circumferentially winding said continuous elongated element around the bearing structure of the tyre in the form of a plurality of coils in mutual side by side relationship.

73. The plant as claimed in claim 71, wherein the underlayer-forming location comprises a strip-dispensing assembly for dispensing at least one continuous strip of elastomeric material having a cross-section substantially corresponding to a cross-section of the underlayer, and cutting devices for cutting to size a strip segment of predetermined length from said continuous strip.

74. The plant as claimed in claim 71, further comprising heating devices for supplying heat to the underlayer before application of the blocks.

75. The plant as claimed in claim 71, further comprising heating devices for supplying heat to the blocks before applying the blocks to the underlayer.

76. The plant as claimed in claim 74, wherein said heating devices operate in a vicinity of the block-applying location.

77. The plant as claimed in claim 71, wherein the block-forming location comprises a bar-dispensing assembly for supplying a continuous bar of raw elastomeric material and cutting devices for cutting bar segments of predetermined length from said continuous bar.

78. The plant as claimed in claim 77, wherein the block-forming location further comprises moulding members operating downstream of said cutting devices and upstream of the block-applying location for shaping the blocks by plastic deformation.

79. The plant as claimed in claim 71, wherein the block-applying location comprises a rest surface for the underlayer and a handling device for laying the blocks on the underlayer supported by the rest surface.

80. The plant as claimed in claim 79, wherein said handling device is designed to lay at least one of said blocks protruding from a second end portion of the underlayer.

81. The plant as claimed in claim 71, wherein the block-applying location comprises a handling device for laying the blocks on the underlayer applied around the bearing structure of the tyre.

82. The plant as claimed in claim 79, wherein said handling device comprises a gripper having jaws movable between an open condition in which said jaws are mutually spaced apart and a closed condition in which they are mutually approached so as to define a concave seat the shape of which matches the shape of one of said blocks.

83. The plant as claimed in claim 79, wherein said handling device comprises a presser member to compress the blocks against an outer surface of the underlayer.

84. The plant as claimed in claim 71, wherein said devices for curing the tyre comprise:
a mould having forming recesses corresponding to respective blocks of the tyre; and
reference indices for aligning the blocks with respective forming recesses before closing the mould, so that each block is engaged in a respective forming recess following closure of the mould.

85. The plant as claimed in claim 84, wherein said reference indices comprise a fixed reference that can be made coincident with at least one reference index carried by the tyre and indicative of an angular position of the blocks around a geometric rotation axis of the tyre.

86. The plant as claimed in claim 71, further comprising devices for associating at least one reference index with the tyre, said index being indicative of an angular position of the blocks around a geometric axis of the tyre, said blocks being operatively disposed upstream of the devices for curing the tyre.

87. The plant as claimed in claim 84, wherein said forming recesses are defined in respective sectors that can be centripetally moved close to each other concurrently with closure of the mould.

88. A green tyre for vehicle wheels comprising a tread band of elastomeric material circumferentially disposed around a bearing structure incorporating reinforcing cords, wherein the tread band comprises:
an underlayer circumferentially extending around the bearing structure; and
a plurality of blocks mutually spaced apart according to a predetermined tread pattern, each block having an attachment surface applied against an outer surface of the underlayer.

89. The tyre as claimed in claim 88, wherein the underlayer has a substantially constant cross-section profile along a longitudinal extension thereof.

90. The tyre as claimed in claim 88, wherein the underlayer comprises at least one continuous elongated element of raw elastomeric material circumferentially extending into a plurality of coils disposed in mutual side by side relationship around the bearing structure.

91. The tyre as claimed in claim 88, wherein the underlayer comprises at least one strip segment of elastomeric material of cross-section substantially corresponding to a cross-section of the underlayer.

92. The tyre as claimed in claim 91, wherein said strip segment has a first end portion and a second end portion mutually joined end-to-end.

93. The tyre as claimed in claim 92, wherein said end portions have a line of mutual connection extending along a hollow part defined in a tread pattern between circumferentially contiguous blocks.

94. The tyre as claimed in claim 92, wherein at least one of said blocks protrudes from a second end portion of the underlayer and is applied against a first end portion of the underlayer.

95. The tyre as claimed in claim 88, wherein at least one of said blocks comprises a bar segment separated from a continuous bar of extruded elastomeric material.

96. The tyre as claimed in claim 88, further comprising at least one reference index indicative of an angular position of the blocks around a geometric rotation axis of the tyre.

97. The tyre as claimed in claim 88, wherein the underlayer is made of an elastomeric material different from the elastomeric material of the blocks.

98. The tyre as claimed in claim 88, where the green tyre is cured and moulded.
